(19) United States
(12) Patent Application Publication
(10) Pub. No.: US 2016/0036532 A1
(43) Pub. Date: Feb. 4, 2016

(54) OPTICAL MODULATOR, OPTICAL TRANSMITTER, OPTICAL TRANSMISSION/RECEPTION SYSTEM, AND CONTROL METHOD FOR OPTICAL MODULATOR

(71) Applicant: NEC CORPORATION, Tokyo (JP)

(72) Inventor: Hidemi NOGUCHI, Tokyo (JP)

(21) Appl. No.: 14/775,831

(22) PCT Filed: Nov. 25, 2013
(86) PCT No.: PCT/JP2013/006896

§ 371 Date: Sep. 14, 2015

(30) Foreign Application Priority Data
Mar. 15, 2013 (JP) 2013-053193

(51) Int. Cl. H04B 10/556; H04B 10/564; H04B 10/079

(52) U.S. Cl. CPC H04B 10/5561; H04B 10/07955; H04B 10/564

(57) ABSTRACT

To correct and uniform phase shift at each phase modulation area in an optical modulator in operation. An optical modulation unit outputs a four-level modulated optical signal. A signal distribution circuit outputs signals based on an input digital signal. A drive circuit outputs drive signals from drivers and a calibration driver connected to phase modulation areas and calibration phase modulation areas. A control circuit calibrates amplitudes of the drive signals output from the drivers to coincide with phase shifts by the calibration phase modulation areas according to light intensity of the optical signal.

### TECHNICAL FIELD

The present invention relates to an optical modulator, an optical transmitter, an optical transmission/reception system, and a control method for an optical modulator.

### BACKGROUND ART

With an explosive increase in demand of a broadband multimedia communication service such as the Internet or a high-definition digital TV broadcast, a dense wavelength-division multiplexing optical fiber communication system, which is suitable for a long-distance and large-capacity transmission and is highly reliable, has been introduced in trunk line networks and metropolitan area networks. In access networks, an optical fiber access service spreads rapidly. In such an optical fiber communication system, cost reduction for laying optical fibers as optical transmission lines and improvement of spectral efficiency per optical fiber are important. Therefore, a wavelength-division multiplexing technology which multiplexes multiple optical signals having different wavelengths is widely used.

In an optical transmitter for such a high-capacity wavelength-division multiplexing communication system, an optical modulator is required. In the optical modulator, high speed operation with small wavelength dependence is indispensable. Further, an unwanted optical phase modulation component which degrades the waveform of the received optical signal after long-distance transmission (in the case of using light intensity modulation as a modulation method), or an light intensity modulation component (in the case of using optical phase modulation as a modulation method) should be suppressed as small as possible. A Mach-Zehnder (MZ) light intensity modulator in which waveguide-type optical phase modulators are embedded into an optical waveguide-type MZ interferometer is suitable for such a use.

To increase the transmission capacity per wavelength channel, a multilevel optical modulation signal system having a smaller optical modulation spectrum bandwidth than a typical binary light intensity modulation system is advantageous in terms of the spectral efficiency, wavelength dispersion of an optical fiber, and resistance to polarization mode dispersion, each of which poses a problem. This multilevel optical modulation signal system is considered to become mainstream particularly in optical fiber communication systems in trunk line networks exceeding 40 Gb/s, the demand for which is expected to increase in the future. For such use, a monolithically integrated multilevel optical modulator in which two MZ light intensity modulators described above and an optical multiplexer/demultiplexer are used in combination has recently been developed.

In high speed optical modulation by using this optical modulator, especially in the high-frequency region in which the frequency of a modulation electric signal is over 1 GHz, the propagating wavelength of the modulation electric signal becomes not negligibly short compared with the length of an electrode formed in an optical phase modulation region in the optical modulator. Therefore, voltage distribution of the electrode serving as measure for applying an electric field to the optical phase modulator is no longer regarded as uniform in an optical signal propagation axis direction. To estimate optical modulation characteristics exactly, it is required to treat the electrode as a distributed constant line and treat the modulation electric signal propagating through the optical phase modulation area as a traveling-wave, respectively. In that case, in order to increase the effective interaction length with the modulated optical signal and the modulation electric signal, a so-called traveling-wave type electrode which is devised to make a phase velocity vo of the modulated optical signal and a phase velocity vm of the modulation electric signal as close to each other as possible (phase velocity matching) is required.

An optical modulator module having a segmented electrode structure to realize the traveling-wave type electrode and the multilevel optical modulation signal system has already been proposed (Patent Literature 1 to 3). An optical modulator module capable of performing multilevel control of a phase variation of a modulated optical signal in each segmented electrode has also been proposed (Patent Literature 4). This optical modulator module is a compact, broad-band, and low-drive-voltage optical modulator module capable of generating any multilevel optical modulation signal, while maintaining phase velocity matching and impedance matching, which are required for a traveling-wave structure operation, by inputting a digital signal.

### CITATION LIST

### Patent literature

Patent Literature 1: Japanese Unexamined Patent Application Publication No. H07-13112
Patent Literature 2: Japanese Unexamined Patent Application Publication No. H05-289033
Patent Literature 3: Japanese Unexamined Patent Application Publication No. H05-257102
Patent Literature 4: International Patent Publication No. WO 2011/043079

### SUMMARY OF INVENTION

### Technical Problem

However, the present inventor has found that the optical modulator module that includes the segmented electrode structure described above has the problem as described below. For example, in the case of using the MZ optical modulator of the segmented electrode structure, dispersion of phase shift in each segmented electrode occurs due to production tolerance, temperature fluctuation and aging degradation, etc. As a result, dispersion of light intensity of an optical signal output from the optical modulator module occurs. In order to correct such dispersion of characteristics, output amplitude of drivers that output drive signals to the segmented electrodes may be individually adjusted with monitoring the light intensity of the optical signal by a measurement device when shipping inspection is performed or an optical communication system is started up.

As described above, this method is effective for primary production tolerance. However, in order to correct the dispersion of the characteristics such as the temperature fluctuation, power supply fluctuation, and the aging degradation that are caused when the optical communication system operates, it is necessary to stop the communication or the system once to correct the dispersion. However, for example, it is supposed that the optical communication system of the trunk line networks continuously operates for a prolonged time, and it is unacceptable that the communication or the system is stopped to correct the dispersion.

The present invention has been made in view of the above-mentioned problem, and an object of the present invention is to correct and uniform phase shift at each phase modulation area in an optical modulator in operation.

### Solution to Problem

An aspect of the present invention is an optical modulator including: an optical modulation unit that modulates an input light into an optical signal of n (n is an integer equal to or more than two) levels and outputs the optical signal, a plurality of phase modulation areas being formed on a waveguide in the optical modulation unit; a signal distribution circuit that outputs a signal based on an input digital signal; a drive circuit that includes a plurality of drivers connected to the plurality of phase modulation areas, respectively, and outputs drive signals according to the signal based on the input digital signal to the plurality of drivers connected to the plurality of phase modulation areas, respectively; and a control circuit that calibrates amplitude of the drive signal output from each driver connected to a phase modulation area that is a calibration objective and is other than a phase modulation area that is a calibration reference according to light intensity of the optical signal in order to coincide with a phase shift by the phase modulation area that is the calibration reference in the plurality of phase modulation areas.

An aspect of the present invention is an optical transmitter including: an optical modulation unit that modulates an input light into an optical signal of n (n is an integer equal to or more than two) levels and outputs the optical signal, a plurality of phase modulation areas being formed on a waveguide in the optical modulation unit; a light source that outputs the input light; a monitor unit that monitors light intensity of the optical signal; a signal distribution circuit that outputs a signal based on an input digital signal; a drive circuit that includes a plurality of drivers connected to the plurality of phase modulation areas, respectively, and outputs drive signals according to the signal based on the input digital signal to the plurality of drivers connected to the plurality of phase modulation areas, respectively; and a control circuit that calibrates amplitude of the drive signal output from each driver connected to a phase modulation area that is a calibration objective and is other than a phase modulation area that is a calibration reference according to the light intensity of the optical signal in order to coincide with a phase shift by the phase modulation area that is the calibration reference in the plurality of phase modulation areas.

An aspect of the present invention is an optical transmission/reception system including: an optical transmitter that outputs an optical signal; and an optical receptor that receives the optical signal, and including: an optical modulation unit that modulates an input light into the optical signal of n (n is an integer equal to or more than two) levels and outputs the optical signal, a plurality of phase modulation areas being formed on a waveguide in the optical modulation unit; a light source that outputs the input light; a monitor unit that monitors light intensity of the optical signal; a signal distribution circuit that outputs a signal based on an input digital signal; a drive circuit that includes a plurality of drivers connected to the plurality of phase modulation areas, respectively, and outputs drive signals according to the signal based on the input digital signal to the plurality of drivers connected to the plurality of phase modulation areas, respectively; and a control circuit that calibrates amplitude of the drive signal output from each driver connected to a phase modulation area that is a calibration objective and is other than a phase modulation area that is a calibration reference according to the light intensity of the optical signal in order to coincide with a phase shift the phase modulation area that is the calibration reference in the plurality of phase modulation areas.

An aspect of the present invention is a control method for an optical modulator including: monitoring light intensity of an optical signal output from an optical modulation unit that modulates an input light into the optical signal of n (n is an integer equal to or more than two) levels and outputs the optical signal by a plurality of phase modulation areas formed on a waveguide; generating a signal based on an input digital signal; outputting drive signals to corresponding phase modulation areas from a plurality of drivers connected to the plurality of phase modulation area, respectively, according to the signal based on the input digital signal; calibrating amplitude of the drive signal output from each driver connected to a phase modulation area that is a calibration objective and is other than a phase modulation area that is a calibration reference according to the light intensity of the optical signal in order to coincide with a phase shift the phase modulation area that is the calibration reference in the plurality of phase modulation areas.

### Advantageous Effects of Invention

According to the present invention, it is possible to correct and uniform amounts of phase modulations at phase modulation areas in an optical modulator in operation.

### BRIEF DESCRIPTION OF DRAWINGS

FIG. 1 is a block diagram schematically showing a configuration of the general multilevel optical transmitter 6000 including the segmented electrode structure

FIG. 2 is a plane view schematically showing a configuration of an optical modulator 600.

FIG. 3A is a diagram schematically showing a configuration of an optical multiplexer/demultiplexer 613.

FIG. 3B is a diagram schematically showing a configuration of an optical multiplexer/demultiplexer 613.

FIG. 4 is a table of an operation showing an operation of the optical modulator 600.

FIG. 5 is a diagram schematically showing an aspect of propagation of the light in the optical modulator 600.

FIG. 6A is a constellation diagram of lights L1 and L2 when phase modulations by phase modulation areas PM61_0 to PM61_2 and phase modulation areas PM62_0 to PM62_2 are not applied.

FIG. 6B is a constellation diagram of the lights L1 and L2 when a binary code of the input digital signal is “00” in the optical modulator 600.

FIG. 6C is a constellation diagram showing an optical modulation in the optical modulator 600.

FIG. 7 is a block diagram schematically showing a configuration of an optical transmitter 1000 according to a first exemplary embodiment.

FIG. 8 is a block diagram schematically showing a configuration of an optical modulator 100 according to the first exemplary embodiment.

FIG. 9 is a diagram schematically showing a configuration of a signal distribution circuit 12.

FIG. 10 is a flow chart showing a procedure of a calibration operation of the optical modulator 100.

FIG. 11A is a timing chart showing an aspect of the calibration operation of the optical modulator 100.

FIG. 11B is an enlarged view showing intensity of the output optical signal acquired by referring to light intensity information INF between a timing t3 and a timing t4 shown in FIG. 11A.

FIG. 12A is a constellation diagram of the optical modulator 100 when φ0+φ1+φ2=Δ3θ is approximately π/2.

FIG. 12B is a constellation diagram of the optical modulator 100 when φ0+φ1+φ2=Δ3θ is approximately π.

FIG. 13 is a block diagram schematically showing a configuration of an optical modulator 200 that is a segmented-electrode-structured MZ multilevel optical intensity modulator according to a second exemplary embodiment.

FIG. 14 is a flow chart showing a procedure of a driver calibration operation of the optical modulator 200.

FIG. 15 is a constellation diagram of the optical modulator 200 when φ0+φ1+φ2 is approximately π.

FIG. 16 is a plane view schematically showing a configuration of an optical transmission/reception system 300 according to a third exemplary embodiment.

### DESCRIPTION OF EMBODIMENTS

### EXAMPLE 1

Exemplary embodiments of the present invention will be described below with reference to the drawings. The same components are denoted by the same reference numerals throughout the drawings, and a repeated explanation is omitted as needed.

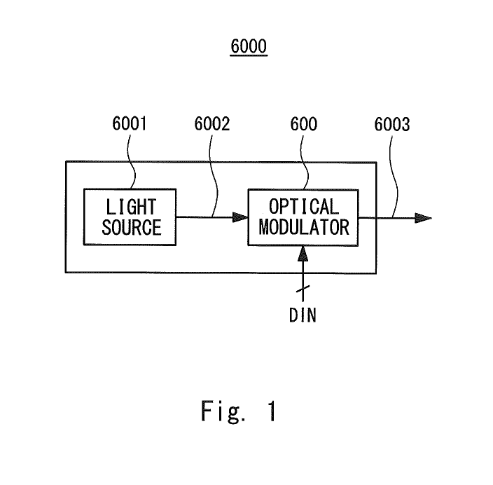

A general multilevel optical transmitter 6000, which includes a segmented electrode structure, shall be described as a premise for understanding a configuration and an operation of optical modulators according to following embodiments. The optical transmitter 6000 is a multilevel-modulation optical transmitter. However, the optical transmitter 6000 is described as a 2-bit optical modulator for simplifying an explanation of that. FIG. 1 is a block diagram schematically showing a configuration of the general multilevel optical transmitter 6000 including the segmented electrode structure. The optical transmitter 6000 includes a light source 6001 and an optical modulator 600.

The light source 6001, which typically consists of a laser diode, outputs CW (Continuous Wave) light 6002 to the optical modulator 600, for example. The optical modulator 600 is a 2-bit optical modulator. The optical modulator 600 modulates the input CW light 6002 according into an input digital signal DIN, which is a 2-bit digital signal, to output a 2-bit (four levels) optical signal 6003.

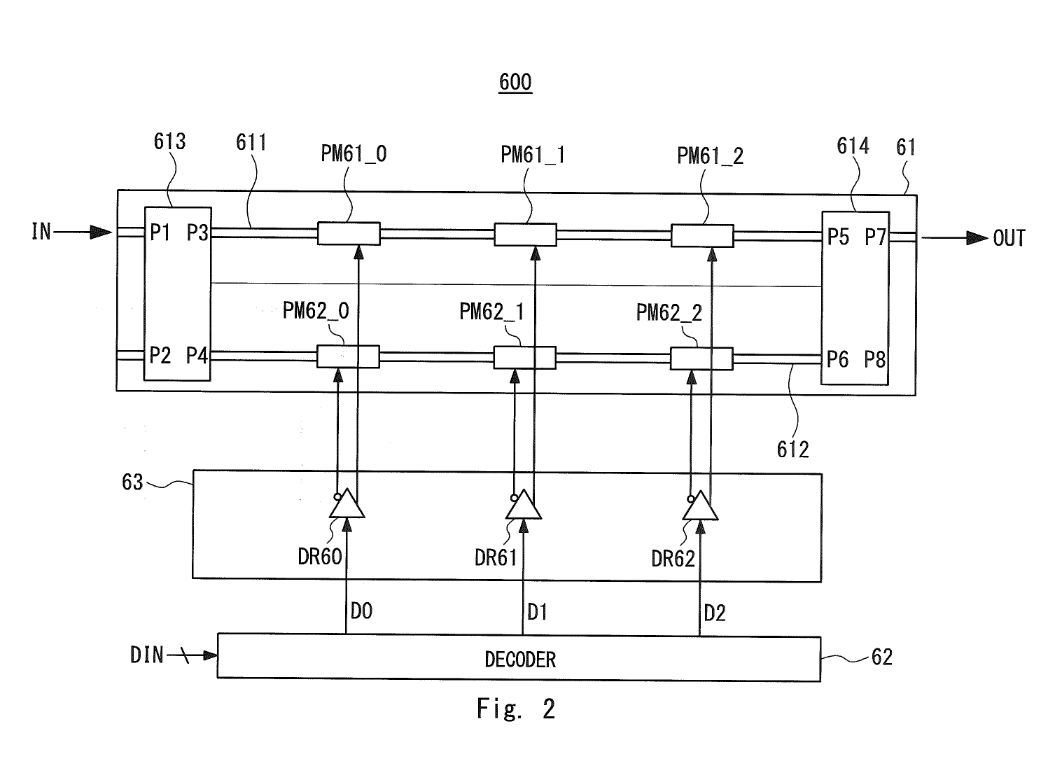

Next, a MZ-type multilevel light intensity modulator of a general segmented electrodes structure shall be described. FIG. 2 is a plane view schematically showing a configuration of the optical modulator 600 that is the MZ-type multilevel light intensity modulator. The optical modulator 600 includes an optical modulation unit 61, a decoder 62, and a drive circuit 63.

The optical modulation unit 61 outputs an optical signal OUT modulated from an input light IN. The optical modulation unit 61 includes optical waveguides 611 and 612, an optical multiplexer/demultiplexer 613, an optical multiplexer/demultiplexer 614, phase modulation areas PM61_0 to PM61_2 and PM62_0 to PM62_2. The optical waveguides 611 and 612 are arranged in parallel.

The optical multiplexer/demultiplexer 613 is inserted at a side of an optical input (the input light IN) of the optical waveguides 611 and 612. At an input side of the optical multiplexer/demultiplexer 613, the input light IN is input to an input port P1 and nothing is input to an input port P2. At an output side of the optical multiplexer/demultiplexer 613, the optical waveguide 611 is connected to an output port P3 and the optical waveguide 612 is connected to an output port P4.

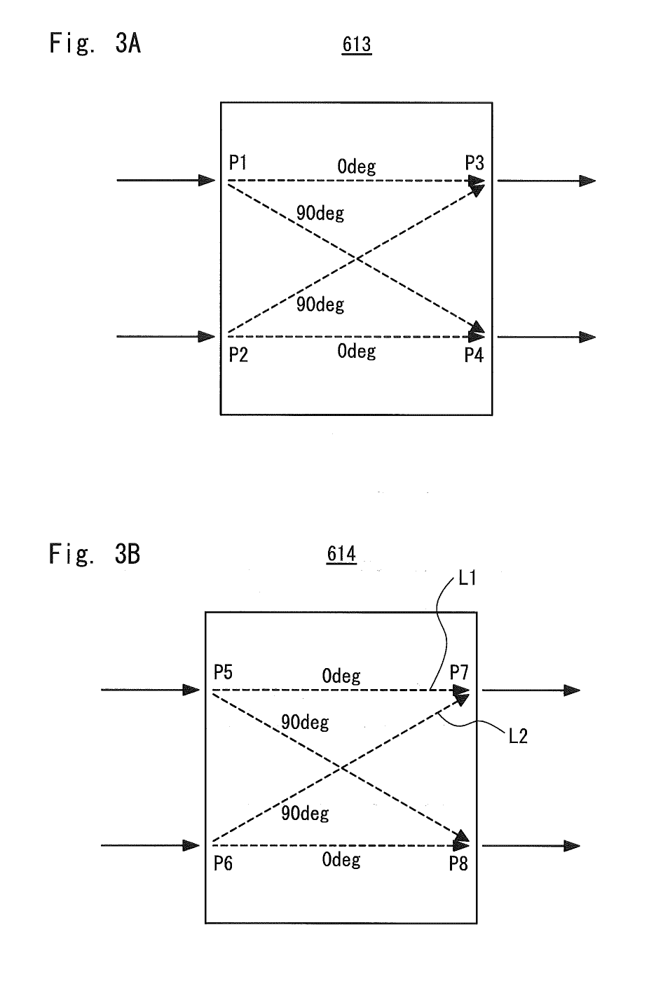

FIG. 3A is a diagram schematically showing a configuration of the optical multiplexer/demultiplexer 613. In the optical multiplexer/demultiplexer 613, the light incident on the input port P1 propagates to the output ports P3 and P4. However, a phase of the light propagating from the input port P1 to the output port P4 delays by 90 degrees as compared with the light propagating from the input port P1 to the output port P3. The light incident on the input port P2 propagates to the output ports P3 and P4. However, a phase of the light propagating from the input port P2 to the output port P3 delays by 90 degrees as compared with the light propagating from the input port P2 to the output port P4.

The optical multiplexer/demultiplexer 614 is inserted at a side of an optical signal output (the optical signal OUT) of the optical waveguides 611 and 612. At an input side of the optical multiplexer/demultiplexer 614, the optical waveguide 611 is connected to an input port P5 and the optical waveguide 612 is connected to an input port P6. At an output side of the optical multiplexer/demultiplexer 614, the optical signal OUT is output from an output port P7.

FIG. 3B is a diagram schematically showing a configuration of the optical multiplexer/demultiplexer 614. The optical multiplexer/demultiplexer 614 has the same configuration as the optical multiplexer/demultiplexer 613. The input ports P5 and P6 correspond to the input ports P1 and P2 of the optical multiplexer/demultiplexer 613, respectively. The output port P7 and an output port P8 correspond to the output ports P3 and P4 of the optical multiplexer/demultiplexer 613, respectively. The light incident on the input port P5 propagates to the output ports P7 and P8. However, a phase of the light propagating from the input port P5 to the output port P8 delays by 90 degrees as compared with the light propagating from the input port P5 to the output port P7. The light incident on the input port P6 propagates to the output ports P7 and P8. However, a phase of the light propagating from the input port P6 to the output port P7 delays by 90 degrees as compared with the light propagating from the input port P6 to the output port P8.

Note that the optical multiplexer/demultiplexer 613 and the optical multiplexer/demultiplexer 614 are mentioned as an example of an optical multiplexing/demultiplexing measure. Hence, any optical multiplexing/demultiplexing measure such as Y-branch waveguide that can split an input light IN in to two and multiplex lights from two waveguides can be used.

The phase modulation areas PM61_˜PM61_2 are arranged on the optical waveguide 611 between the optical multiplexer/demultiplexer 613 and the optical multiplexer/demultiplexer 614. The phase modulation areas PM62_˜PM62_2 are arranged on the optical waveguide 612 between the optical multiplexer/demultiplexer 613 and the optical multiplexer/demultiplexer 614.

Here, the phase modulation area is an area that includes an electrode formed on the optical waveguide. An effective refractive index of the optical waveguide below the electrode is changed by applying an electric signal, e.g., a voltage signal, to the electrode. As a result, a substantial optical length of the optical waveguide in the phase modulation area can be changed. Thus, the phase modulation area can change the phase of the optical signal propagating through the optical waveguide. Then, the optical signal can be modulated by providing the optical signals propagating through the two optical waveguides 611 and 612 with a phase difference. That is, the optical modulation unit 61 constitutes a multilevel Mach-Zehnder optical modulator that includes two arms and the segmented electrode structure.

The decoder 62 decodes the 2-bit input digital signal DIN, and, for example, outputs signals of temperature gauge codes D0 to D2 to the drive circuit 63.

The drive circuit 63 includes binary drivers DR60 to DR62. The signals D0 to D2 are supplied to the drivers DR60 to DR62, respectively. Each of the drivers DR60 to DR62 outputs a pair of the differential output signals according to the signals D0 to D2. In this case, in-phase output signals of the differential output signals output from the drivers DR60 to DR62 are output to the phase modulation areas PM61_0 to PM61_2, respectively. Reverse phase output signals of the differential output signals output from the drivers DR60 to DR62 are output to the phase modulation areas PM62_0 to PM62_2, respectively.

Here, the differential output signals output from the drivers DR60 to DR62 shall be described. As described above, the drivers DR60 to DR62 are binary output (0, 1) drivers. That is, the drivers DR60 to DR62 output “0” or “1” as the in-phase output signals according to values of the signals D0 to D2.

Meanwhile, the drivers DR60 to DR62 output inverted signals of the in-phase output signals as the reverse phase output signals. That is, the drivers DR60 to DR60 output “1” or “0” as the reverse phase output signals according to values of the signals D0 to D2.

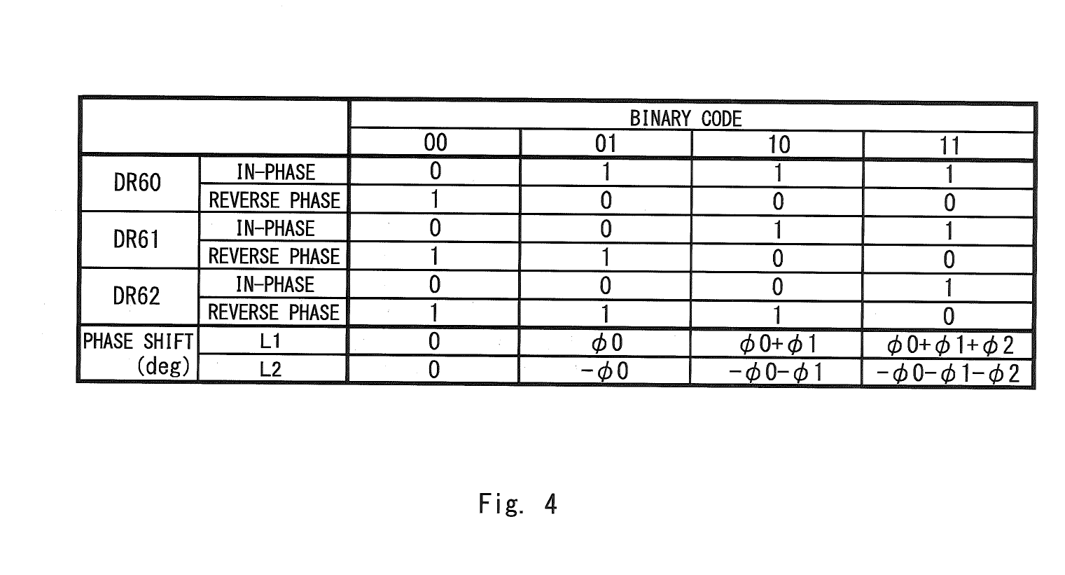

FIG. 4 is a table of an operation showing an operation of the optical modulator 600. The driver DR60 outputs “0” as the in-phase output signal and “1” as the reverse output signal when the input digital signal DIN is “00”. The driver DR60 outputs “1” as the in-phase output signal and “0” as the reverse output signal when the input digital signal DIN is equal to or more than “01”.

The driver DR61 outputs “0” as the in-phase output signal and “1” as the reverse output signal when the input digital signal DIN is equal to or less than “01”. The driver DR61 outputs “1” as the in-phase output signal and “0” as the reverse output signal when the input digital signal DIN is equal to or more than “10”.

The driver DR62 outputs “0” as the in-phase output signal and “1” as the reverse output signal when the input digital signal DIN is equal to or less than “10”. The driver DR62 outputs “1” as the in-phase output signal and “0” as the reverse output signal when the input digital signal DIN is “11”. In the table of the operation, phase shifts by the drivers DR60 to DR62 are referred to as φ0, φ1, and φ2, respectively. Four-level phase modulation of 0, φ0, φ0+φ1, and φ0+φ1+φ2 for a light L1 propagating through the optical waveguide 611 can be achieved according to four states of the input digital signal DIN of “00”, “01”, “10”, and “11”, respectively. Further, four-level phase modulation of 0, −φ0, −φ0−φ1, and −φ0−φ1−φ2 for a light L2 propagating through the optical waveguide 612 can be achieved, respectively. Note that the counterclockwise direction is defined as a phase delay and “+” is defined as a sign of this case.

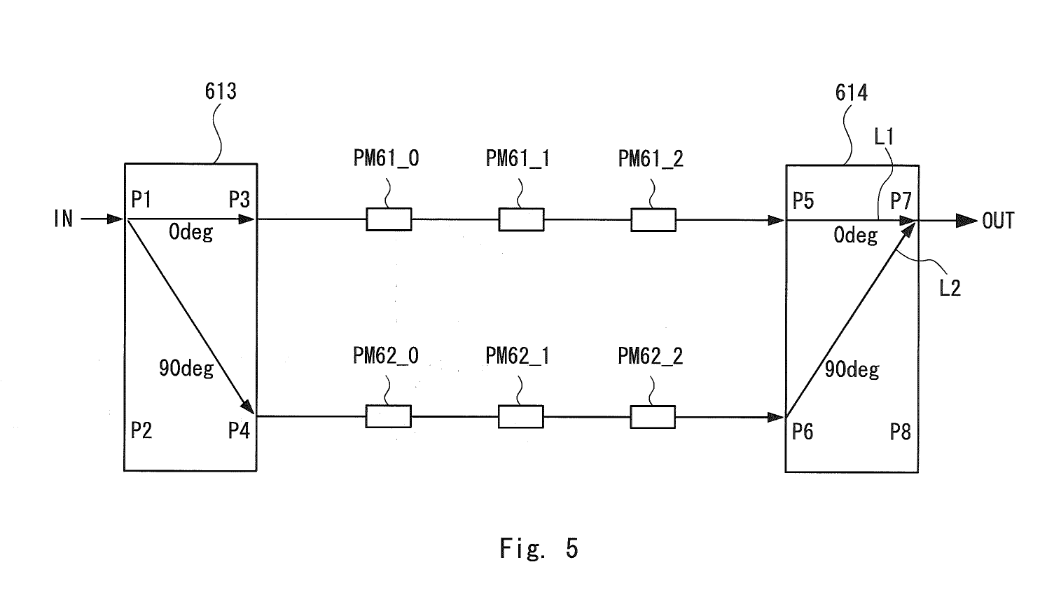

Here, a phase modulation operation of the optical modulator 600 shall be described. FIG. 5 is a diagram schematically showing an aspect of propagation of the light in the optical modulator 600. In this example, as shown in FIG. 5, the input light IN is incident on the input port P1 of the optical multiplexer/demultiplexer 613. Thus, the phase of the light output from the output port P4 is delayed by 90 degrees as compared with the light output from the output port P3. After that, the light output from the output port P3 passes through the phase modulation areas PM61_0 to PM61_2 and reaches the input port P5 of the optical multiplexer/demultiplexer 614. The light reaching the input port P5 reaches the output port P7 as-is. Meanwhile, the light output from the output port P4 passes through the phase modulation areas PM62_0 to PM62_2 and reaches the input port P6 of the optical multiplexer/demultiplexer 614. The light reaching the input port P6 reaches the output port P7 after the phase thereof is further delayed by 90 degrees.

In other words, a phase of the light L2 reaching the output port P7 from the input port P6 is delayed by 180 degrees as compared with the light L1 reaching the output port P7 from the input port P5 even when the phase modulations by the phase modulation areas PM61_0 to PM61_2 and phase modulation areas PM62_0 to PM62_2 are not applied.

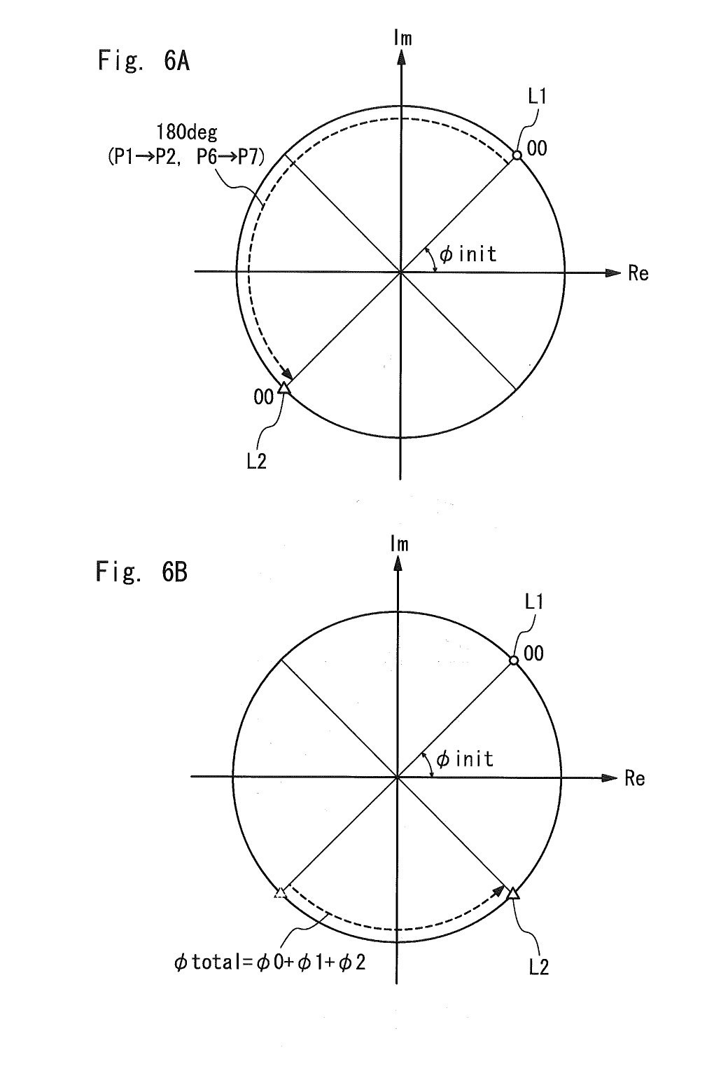

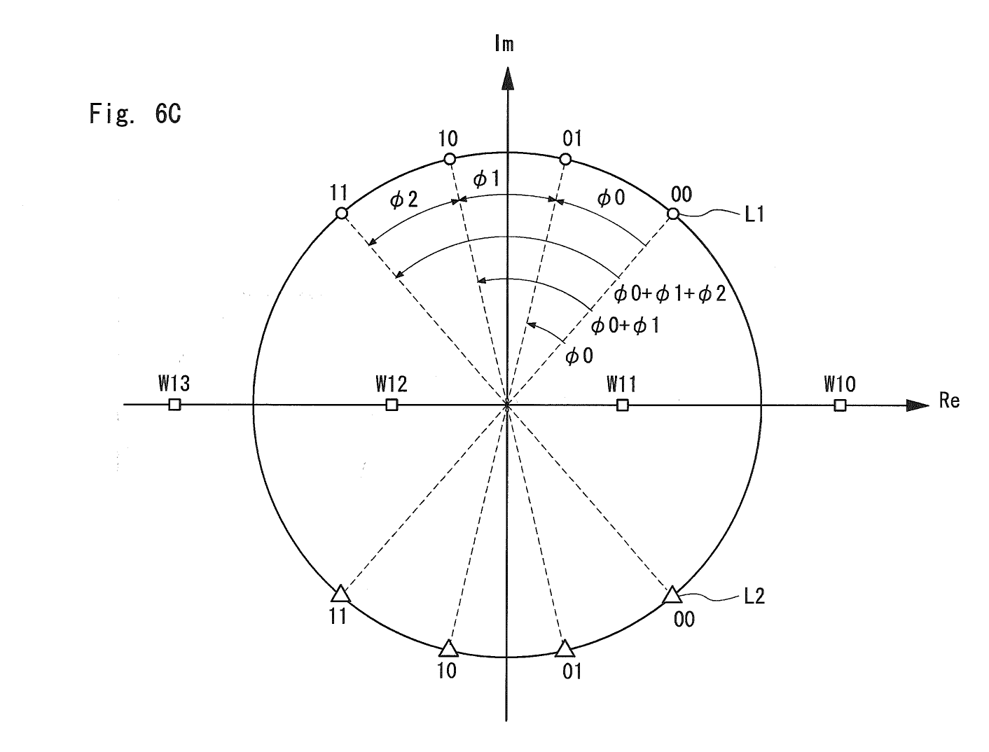

FIG. 6A is a constellation diagram of the lights L1 and L2 when the phase modulations by the phase modulation areas PM61_0 to PM61_2 and phase modulation areas PM62_0 to PM62_2 are not applied. As described above, the phase of the light L2 reaching the output port P7 from the input port P6 is delayed by 180 degrees as compared with the light L1 reaching the output port P7 from the input port P5. Here, a phase of an input signal light in an initial state is supposed to be at a phase state of φᵢₙᵢₜ, and the phase of the light L1 is similarly at the phase state of φᵢₙᵢₜ in the initial state “00”.

On the other hand, in the optical modulator 600, the in-phase output signals are input to the phase modulation areas PM61_0 to PM61_2 and the reverse phase output signals are input to the phase modulation areas PM62_0 to PM62_2. Thus, “1” is applied to all of the phase modulation areas PM62_0 to PM62_2 when the input digital signal DIN is in the initial state “00”, it is moved to a place where the phase is further delayed by φtotal (Here, φtotal=φ0+φ1+φ2) in addition to the initial state of the light L2 in FIG. 6A.

To explain in more detail, FIG. 6B is a constellation diagram of the lights L1 and L2 when a binary code of the input digital signal DIN is “00” in the optical modulator 600. Here, “0” is input to the phase modulation areas PM61_0 to PM61_2 and “1”, which is a reverse signal, is input to the phase modulation areas PM62_0 to PM62_2. Therefore, the light L1 is in the phase state of φinit, and the light L2 is in a phase state of φinit+180 deg+φtotal in which phase shift by the phase modulation areas PM62_0 to PM62_2 (φtotal) are added to the initial state of the light L2 shown in FIG. 6A.

FIG. 6C is a constellation diagram showing an optical modulation in the optical modulator 600. Likewise, the phase shifts by the drivers DR60 to DR62 are φ0, φ1, and φ2, respectively. In FIG. 6C, the light L1 has four constellation states of 0, φ0, φ0+φ1, and φ0+φ1+φ2 (counterclockwise) based on the place of φinit shown in FIG. 6B according to the table of the operation shown in FIG. 4. Meanwhile, the light L2 has four constellation states of 0, −φ0, −φ0+φ1, and −φ0+φ1+φ2 (clockwise) based on the place of φinit+180 deg+φtotal shown in FIG. 6B according to the table of operation shown in FIG. 4. Further, in FIG. 6C, output optical signals in this case are illustrated as W10, W11, W12, and W13, respectively. In this case, light intensity of each output optical signal can be illustrated by a distance from the origin. In sum, the output optical signal of the four-level-intensity is acquired when sign information is included. Based on the above, as shown in FIG. 4, the light intensity can be changed in four levels of W10 to W13 including the sign according to the input digital signal DIN, and an optical D/A conversion function can be achieved in the optical transmitter.

Note that FIGS. 6A to 6C show the case that the initial phase of the input optical signal is φinit. Further, for simplifying the drawings, FIGS. 6A to 6C show the case that the light L1 and light L2 can describe a trajectory diphycercal with respect to the Re-axis so that the input optical signal is disposed on the Re-axis in the complex plane. Therefore, the initial value of φinit is not limited to this case. Here, the case that phase variation modulated by the phase modulation area changes in a range of approximately 0 to 90 degrees (π/2) according to the input digital signal, however, it is not limited to this case.

In this case, the phase shifts by the phase modulation areas are the same, respectively, when the optical modulator 600 is in an ideal condition in which each of the phase modulation areas and the drivers operates with the same characteristics. However, in an actual segmented-electrode-structured MZ light intensity modulator, it can be said that it is impossible that each of the phase modulation areas and the drivers has the same characteristics. That is, the characteristics of the phase modulation area fluctuate due to production tolerance, temperature, aging degradation, and so on. Also, in the driver, the characteristics fluctuate due to the production tolerance, the temperature, the aging degradation, supply fluctuation, and so on. Therefore, the phase shift in each phase modulation area actually fluctuates.

Generally, a method for individually adjusting output amplitude of each driver with monitoring optical output amplitude by a measuring instrument and so on are used to correct the fluctuation of the characteristics described above when the shipping inspection of the optical modulation module is done or the optical communication system is started up. However, it can be understood that this method cannot correct the fluctuation of the characteristics of the optical modulator while the system operates or a regular communication is performed.

### First Exemplary Embodiment

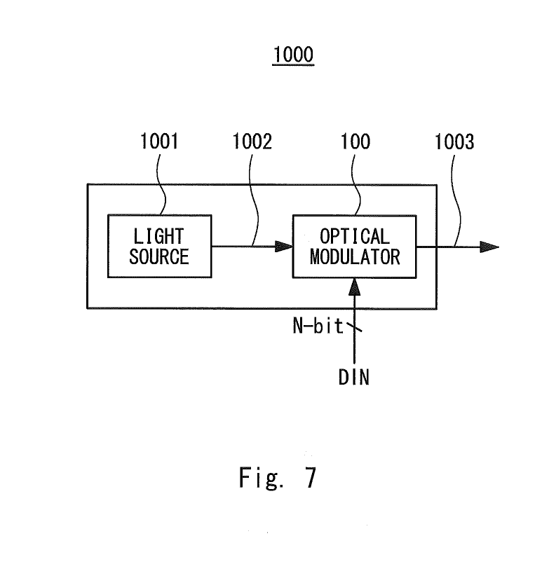

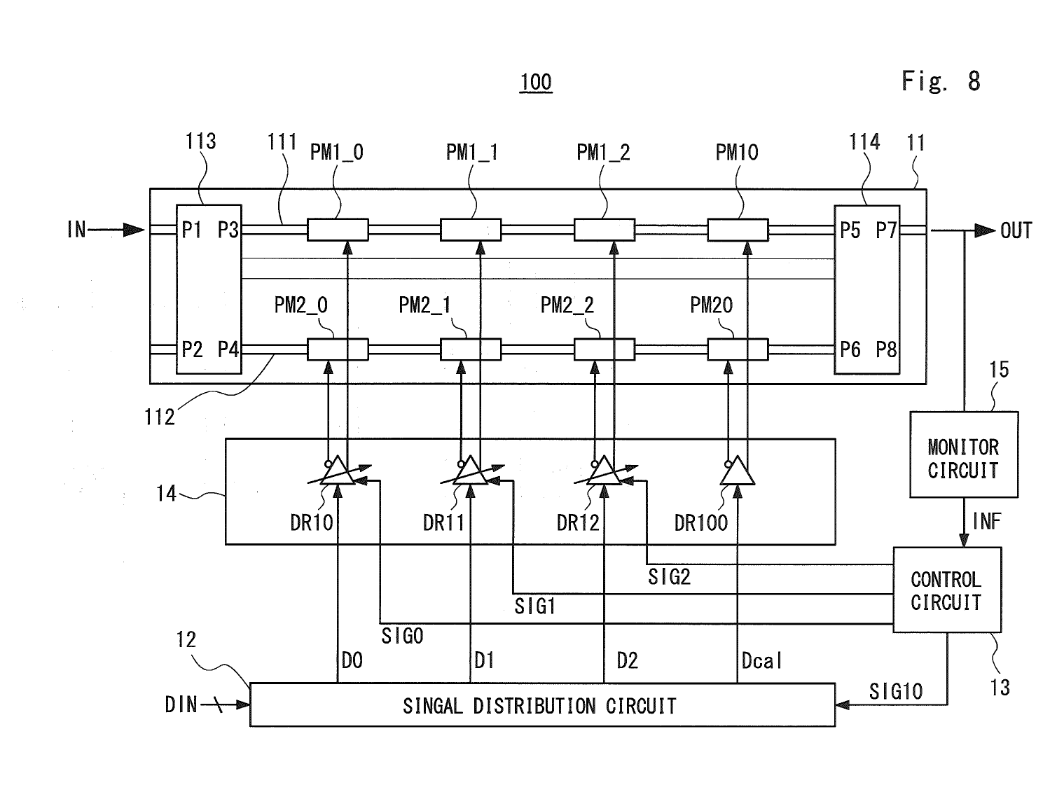

First, an optical transmitter 1000 according to a first exemplary embodiment of the present invention will be described. The optical transmitter 1000 is an optical transmitter that performs an N-bit (N is an integer equal to or more than two) multilevel modulation operation. FIG. 7 is a block diagram schematically showing a configuration of the optical transmitter 1000 according to the first exemplary embodiment. The optical transmitter 1000 includes a light source 1001 and an optical modulator 100.

The light source 1001, which typically consists of a laser diode, outputs CW (Continuous Wave) light 1002 to the optical modulator 100, for example. The optical modulator 100 is an N-bit optical modulator. The optical modulator 100 modulates coverts the input CW light 1002 into a 2^{N}-level optical signal 1003 and outputs the 2^{N}-level optical signal 1003 according to an input digital signal DIN that is an N-bit digital signal.

Next, a segmented-electrode-structured MZ multilevel light intensity modulator according to the first exemplary embodiment will be described. FIG. 8 is a block diagram schematically showing a configuration of the optical modulator 100 that is the segmented-electrode-structured MZ multilevel light intensity modulator according to the first exemplary embodiment. Here, for simplifying the description, an example where the optical modulator 100 is configured as a four-level PAM (Pulse Amplitude Modulation) modulator will be described. Similarly to the optical modulator 600 described above, the optical modulator 100 has the segmented electrode structure. The optical modulator 100 includes an optical modulation unit 11, a signal distribution circuit 12, a control circuit 13, and a drive circuit 14.

The optical modulation unit 11 is configured as a MZ-type optical modulation unit. The optical modulation unit 11 includes optical waveguides 111 and 112, an optical multiplexer/demultiplexer 113, an optical multiplexer/demultiplexer 114, phase modulation areas PM1_0 to PM1_2 and PM2_0 to PM2_2, and calibration phase modulation areas PM10 and PM20. The optical waveguides 111 and 112 correspond to a first and second waveguides, respectively. The optical multiplexer/demultiplexer 113 and optical multiplexer/demultiplexer 114 correspond to a first optical multiplexer/demultiplexer and a second optical multiplexer/demultiplexer, respectively. The calibration phase modulation area PM10 and PM1_0˜PM1_2 correspond to first phase modulation areas. The calibration phase modulation area PM20 and PM2_1˜PM2_7 correspond to second phase modulation areas. The optical modulation unit 11 has a structure of a so-called Mach Zehnder optical resonator in which segmented electrodes (the phase modulation areas PM1_0 to PM1_2 and PM2_0 to PM2_2, and the calibration phase modulation areas PM10 and PM20) are provided on two optical waveguides (the optical waveguides 111 and 112).

The optical waveguides 111 and 112 are arranged in parallel. The optical multiplexer/demultiplexer 113 is inserted at a side of an optical signal input (an input light IN) of the optical waveguides 111 and 112. The optical multiplexer/demultiplexer 113 has the same configuration as the optical multiplexer/demultiplexer 613 described above. At an input side of the optical multiplexer/demultiplexer 113, the input light IN is input to an input port P1 and nothing is input to an input port P2. At an output side of the optical multiplexer/demultiplexer 113, the optical waveguide 111 is connected to an output port P3 and the optical waveguide 112 is connected to an output port P4. Note that the input light IN corresponds to the CW light 1002 of the FIG. 7.

The optical multiplexer/demultiplexer 114 is inserted at a side of an optical signal output (an optical signal OUT) of the optical waveguides 111 and 112. The optical multiplexer/demultiplexer 114 has the same configuration as the optical multiplexer/demultiplexer 614 described above. At an input side of the optical multiplexer/demultiplexer 114, the optical waveguide 111 is connected to an input port P5 and the optical waveguide 112 is connected to an input port P6. At an output side of the optical multiplexer/demultiplexer 114, the optical signal OUT is output from an output port P7. Note that the optical signal OUT corresponds to the optical signal 1003 of the FIG. 7.

The phase modulation areas PM1_0 to PM1_2 and the calibration phase modulation areas PM10 are arranged on the optical waveguide 111 between the optical multiplexer/demultiplexer 113 and the optical multiplexer/demultiplexer 114. The phase modulation areas PM2_0 to PM2_2 and the calibration phase modulation areas PM20 are arranged on the optical waveguide 112 between the optical multiplexer/demultiplexer 113 and the optical multiplexer/demultiplexer 114.

Here, the phase modulation area is an area that includes one electrode (the segmented electrode) formed on the optical waveguide. An effective refractive index of the optical waveguide below the electrode is changed by applying an electric signal, e.g., a voltage signal, to the electrode. As a result, a substantial optical length of the optical waveguide in the phase modulation area can be changed. Thus, phase modulation area can change the phase of the optical signal propagating through the optical waveguide. Then, the optical signal can be modulated by providing the optical signals propagating through the two optical waveguides 111 and 112 with a phase difference. That is, the optical modulation unit 11 constitutes a Mach-Zehnder optical modulator that includes two arms and the segmented electrode structure.

The signal distribution circuit 12 converts the input digital signal DIN that is a four-level (i.e., 2-bit) digital signal into temperature gauge codes. The signal distribution circuit 12 can assign the coveted temperature gauge codes to signals D0 to D2 and Dcal.

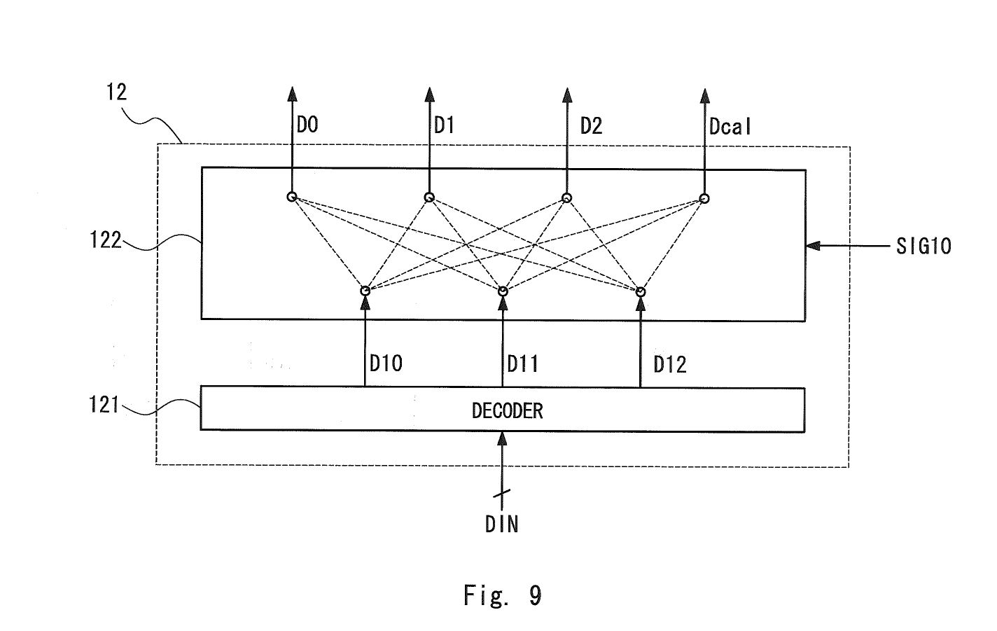

FIG. 9 is a diagram schematically showing a configuration of the signal distribution circuit 12. The signal distribution circuit 12 includes a decoder 121 and a signal distribution unit 122. The decoder 121 converts the input digital signal DIN that is the four-level (i.e., 2-bit) digital signal into the temperature gauge codes D10 to D12. The signal distribution unit 122 assigns the temperature gauge codes D10 to D12 to the signals D0 to D2 and Dcal, respectively, according to a control signal SIG10 from the control circuit 13. The signal distribution unit 122 can fix a value of one of the signals D0 to D2 and Dcal to which none of the temperature gauge codes D10 to D12 is assigned to “0”

The drive circuit 14 includes drivers DR10 to DR12 and a calibration driver DR100. The drivers DR10 to DR12 is configured to be capable of adjusting amplitude of an output drive signal according to a request from the control circuit 13. The signals D0 to D2 are input to the drivers DR10 to DR12. The drivers DR10 to DR12 generates differential signals according to the signals D0 to D2 and outputs the differential signals as the drive signals. Each of the drivers DR10 to DR12 outputs one of the differential signals to each of the phase modulation areas PM1_0 to PM1_2 and outputs the other of the differential signals to each of the phase modulation areas PM2_0 to PM2_2. The signal Dcal is input to the calibration driver DR100. The calibration driver DR100 generates differential signals according to the signal Dcal and outputs the differential signals as a drive signals. The calibration driver DR100 outputs one of the differential signals to the calibration phase modulation area PM10 and outputs the other of the differential signals to the calibration phase modulation area PM20.

Specifically, the driver DR10 outputs an in-phase drive signal to the phase modulation area PM1_0 and outputs a reverse phase signal to the phase modulation area PM2_0. The driver DR11 outputs the in-phase drive signal to the phase modulation area PM1_1 and outputs the reverse phase signal to the phase modulation area PM2_1. The driver DR12 outputs the in-phase drive signal to the phase modulation area PM1_2 and outputs the reverse phase signal to the phase modulation area PM2_2. The calibration driver DR100 outputs the in-phase drive signal to the calibration phase modulation area PM10 and outputs the reverse phase signal to the calibration phase modulation area PM20.

The control circuit 13 controls assignment of the signals D0 to D2 and Dcal in the signal distribution circuit 12. Further, the control circuit 13 regulates amplitudes of the drive signals output from the drivers DR10 to DR12 according to light intensity information INF input from outside. Specifically, the control circuit 13 outputs control signals SIG0 to SIG2 to the drivers DR10 to DR12 to regulate the amplitudes of the drive signals.

Note that a monitor circuit 15 monitors intensity of an output optical signal output from the optical modulation unit 11. Then, the monitor circuit 15 output a monitor result as the light intensity information INF. The monitor circuit 15 may be incorporated in the optical modulator 100 or disposed outside.

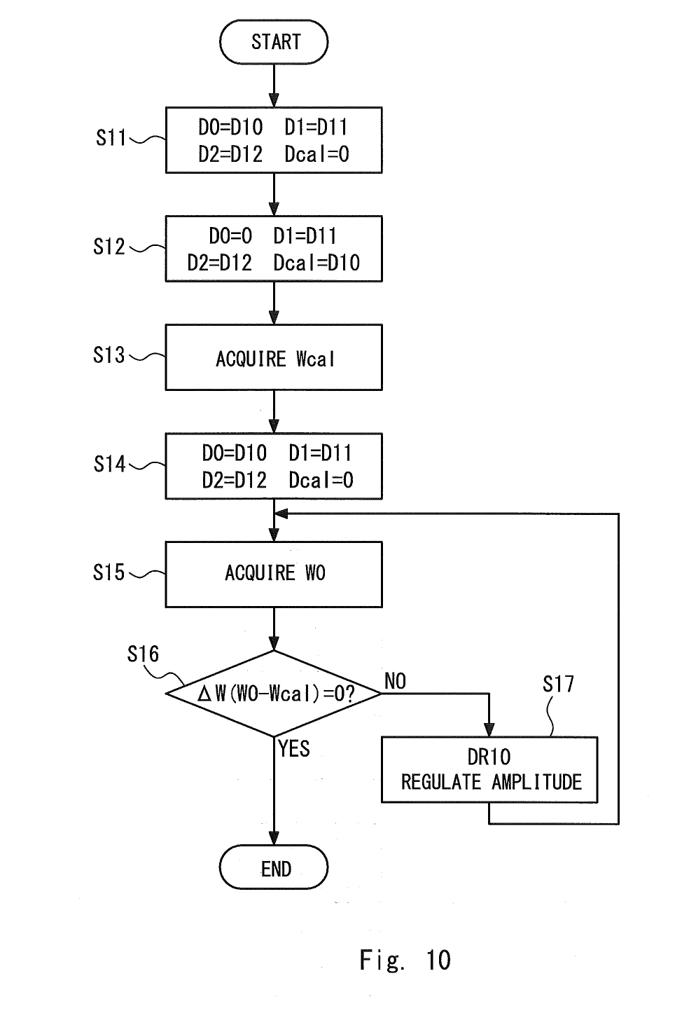

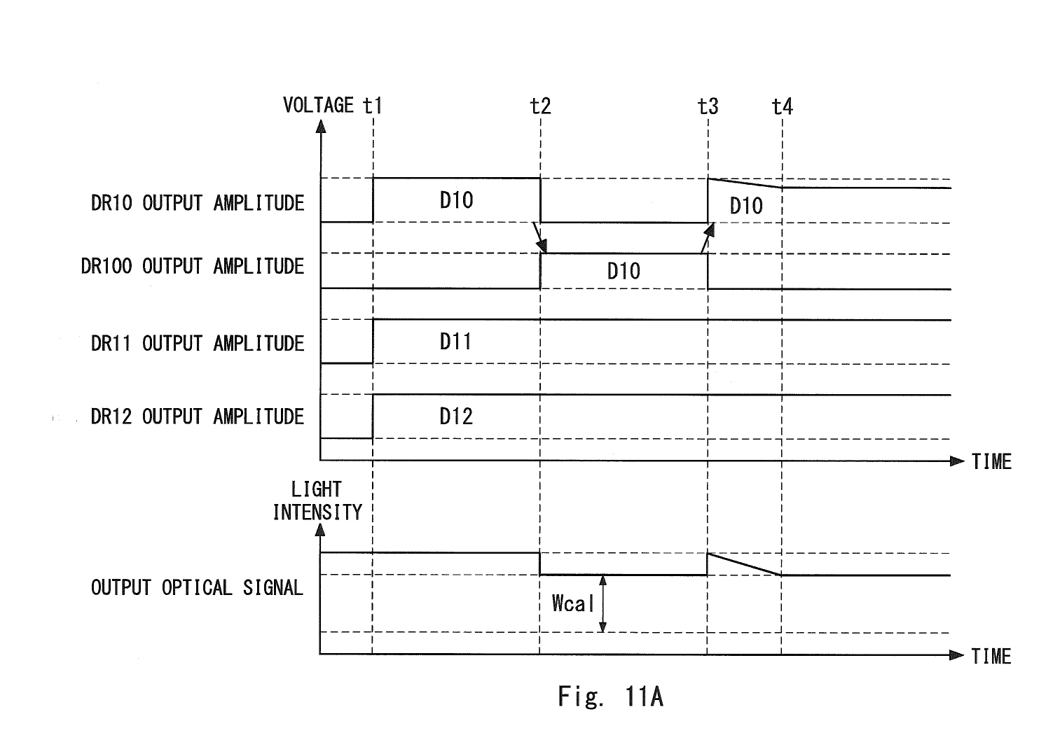

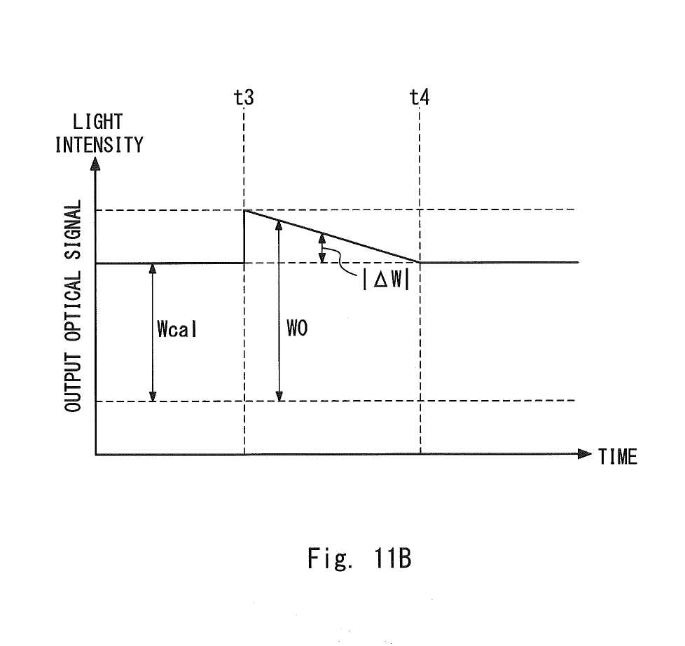

Next, a calibration operation of the optical modulator 100 to suppress the fluctuation of the characteristics will be described. FIG. 10 is a flow chart showing a procedure of the calibration operation of the optical modulator 100. FIG. 11A is a timing chart showing an aspect of the calibration operation of the optical modulator 100. FIG. 11B is an enlarged view showing the intensity of the output optical signal acquired by referring to the light intensity information INF between a timing t3 and a timing t4 shown in FIG. 11A. Here, the driver DR10 is focused on, and an operation of calibrating the driver DR10 will be described.

### Step S11

The calibration driver DR100, and the calibration phase modulation areas PM10 and PM20 does not contribute to the optical modulation when a regular operation is performed and the calibration operation is not performed. In this case, the temperature gauge codes D10 to D12 are assigned to the signals D0 to D2, respectively. Further, the signal Dcal is fixed to “0” (between a timing t1 and a timing t2 in FIGS. 11A and 11B).

### Step S12

When the calibration operation is started, the control circuit 13 changes destinations of the assignment of temperature gauge codes D10 to D12. In this example, the destination of the assignment of the temperature gauge code D10 is changed to the signal Dcal from the signal D0. Then, the value of the signal discharged from the assignment (In this example, it is the signal D0.) is fixed to “0”. That is, the driver DR10 does not contribute to the optical modulation operation. In this case, changing the assignment of the signals is performed in a moment (a time enough shorter than a symbol time of the signal) to prevent the regular communication operation from being interfered (the timing t2 in FIGS. 11A and 11B).

### Step S13

The control circuit 13 refers to the light intensity information INF to acquire light intensity Wcal. In this case, for example, the light intensity Wcal is acquired as an average value of the intensity of the optical signal. Thus, the temporal fluctuation is reduced. Further, the light intensity Wcal acquired here includes the average light intensity information that engages the drivers DR11 and DR12, and the calibration driver DR100.

### Step S14

The control circuit 13 changes the assignments of the temperature gauge codes D10 to D12 and cause those to return to the signal assignment in the regular optical modulation operation. In this example, the assigned destination of the temperature gauge code D10 is returned to the signal D0 from the signal Dcal. Then, the value of the signal Dcal is fixed to “0”. That is, the calibration driver DR100 does not contribute to the optical modulation operation. In this case, the change of the signal assignment is performed in a moment (a time enough shorter than a one symbol time of the signal) to prevent interrupting a regular communication operation (the timing t3 in FIGS. 11A and 11B).

### Step S15

The control circuit 13 refers to the light intensity information INF to acquire light intensity W0. In this case, for example, the light intensity W0 is acquired as the average value of the intensity of the optical signal. Thus, the temporal fluctuation is reduced. Further, the light intensity W0 acquired here includes the average light intensity information that engages the drivers DR10, DR11 and DR12.

### Step S16

The control circuit 13 compares the light intensity Wcal with the light intensity W0 acquired in Steps S13 and S15. That is, it is determined whether ΔW=W0−Wcal=0 is established. Note that ΔW does not need to be strictly zero, and ΔW may have tolerance (e.g., ΔWₘᵢₙ≦ΔW≦ΔWₘₐₓ) within a range capable achieving a required calibration precision. Here, the optical intensities Wcal and W0 include the light intensity information that engages the driver(s) other than the driver DR11 and the calibration driver DR100. However, ΔW can acquire only differential information between the driver DR10 and the calibration driver DR100 by obtaining a difference.

### Step S17

When it is determined that ΔW≠0, the control circuit 13 regulates the amplitude of the driver DR10 by the control signal SIG0 and then returns to Step S15. Thus, regulation operation of Steps S15 and S16 are repeated until ΔW=0 is established. Hence, ΔW=0 is established, so that the light intensity WO when using the driver DR10 is controlled to coincide with the light intensity Wcal when using the calibration driver DR100 (the timing t4 in FIGS. 11A and 11B).

When it is determined that ΔW=0, the calibration of the driver DR10 is finished.

When focusing on the light intensity, it can be understood that ΔW=0 is established by the calibration operation and the light intensity W0 when using the driver DR10 coincides with the light intensity Wcal when using the calibration driver DR100.

Further, the calibration procedure described above is performed on the drivers DR11 and DR12. That is, after that, the phase shifts which the drivers DR10 to DR12 engage can be finally uniformed by applying the procedure of Steps S11 to S17 described above to the drivers DR11 and DR12.

That is, the phase shift at each phase modulation area is adjusted to the phase shift φcal at the calibration phase modulation area, so that the phase modulation of equal spacing can be achieved.

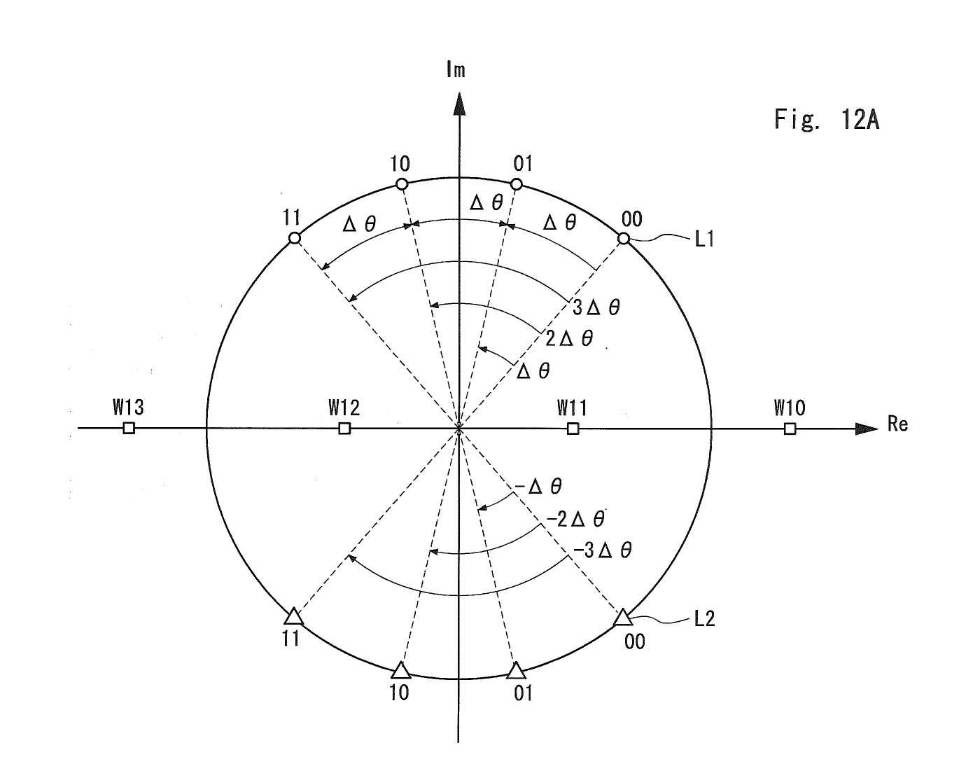

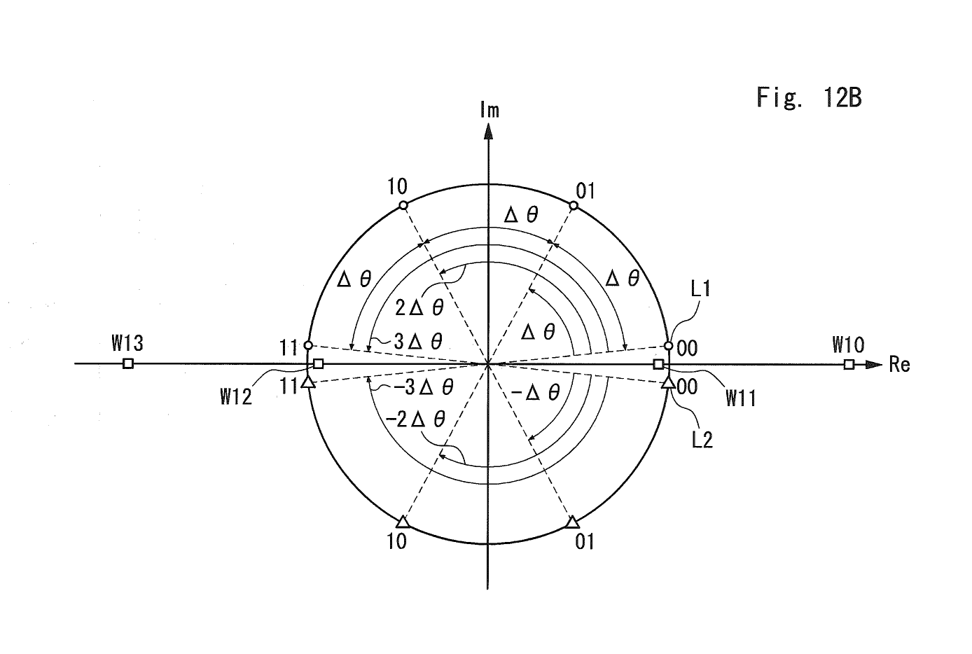

When the phase shifts by the drivers DR10 to DR12 are φ0, φ1, and φ2, respectively, φ0=φ1=φ2 is established by performing the calibration procedure according to the present exemplary embodiment. Here, it is assumed that φ0=φ1=φ2=Δθ. FIG. 12A is a constellation diagram of the optical modulator 100 when φ0+φ1+φ2=Δ3θ is approximately π/2. In FIG. 12A, the output optical signals the phase shifts of which are 0, Δθ, 2Δθ, and 3Δθ are represented as W10, W11, W12, and W13, respectively. Thus, four constellation points based on the phase modulation of equal spacing are obtained. The light intensity can be represented by the distance from the origin. Here, when including information of a sign, the four-level-intensity output optical signal is obtained (Although the optical intensities of W10 and W13 are identical, the signs of those are different. Although the optical intensities of W11 and W12 are identical, the signs of those are different. That is, these mean that the phase of the light is inverted by 180 degrees). As shown in FIG. 12A, when a total phase shift due to the drivers DR10 to DR12 is approximately π/2, intensity spacing of the obtained four-level output optical signal becomes approximately equal spacing.

As described above, according to the optical modulator and calibration operation of the present invention, the optical modulator capable of matching the optical modulation characteristics of the segmented electrodes in the background without interrupting a regular operation of the system and the communication.

### Second Exemplary Embodiment

Next, a segmented-electrode-structured MZ multilevel optical intensity modulator according to a second exemplary embodiment will be described. First, for understanding a technical signification of the segmented-electrode-structured MZ multilevel optical intensity modulator according to the present exemplary embodiment, a constellation diagram of the optical modulator 100 and optical modulator 600 will be described.

First, as shown in FIGS. 6C and 12A, the intensity of the output light has an approximately even intensity spacing in both of the optical modulator 600 and the optical modulator 100 when the total phase shift due to the drivers DR60 to DR62 or the drivers DR10 to DR12 is relatively small (equal to or less than π/2). However, the intensity spacing of the output optical signal becomes uneven when the phase shift of each of the drivers DR60 to DR62 or the drivers DR10 to DR12 approximates π. FIG. 12B is a constellation diagram of the optical modulator 100 when φ0+φ1+φ2=Δ3θ is approximately π. As shown in FIG. 12B, the intensity spacing of the acquired four-level output optical signal is not even. In other words, the intensity of the optical signal in which cosine (cos) characteristics is added to the phase shift of each of the drivers DR60 to DR62 or the drivers DR10 to DR12 is acquired. Therefore, a problem where the linearity of the intensity of the optical signal is deteriorated in the case of the multilevel modulation may be caused.

An optical modulator 200, which is the segmented-electrode-structured MZ multilevel optical intensity modulator according to the present exemplary embodiment, is an alternative example of the optical modulator 100 and is configured as an optical modulator having the linearity of the intensity of the optical signal. Specifically, the amplitudes of the output signals of the drivers DR10 to DR12 are regulated and arccosine (ARCCOS) characteristics are provided to the phase shift of each phase modulation area in advance, so that the output optical signal having the four-level output optical signal intensity with even spacing is acquired.

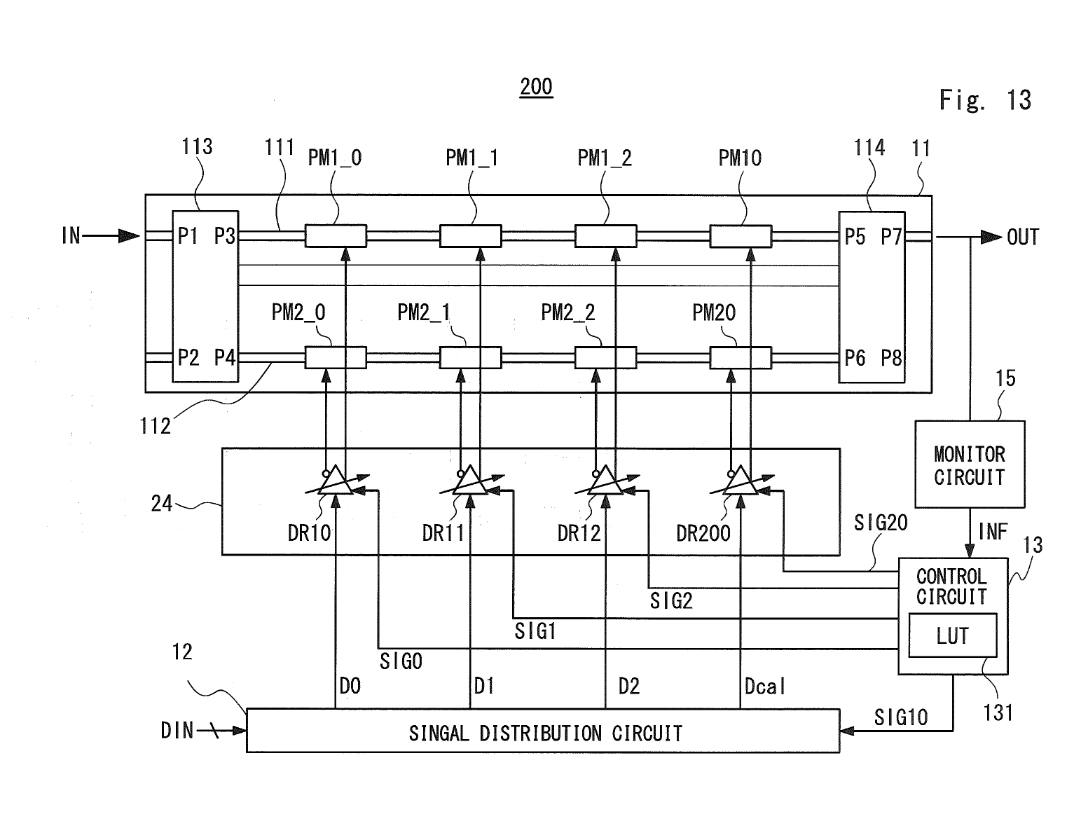

FIG. 13 is a block diagram schematically showing a configuration of the optical modulator 200 that is the segmented-electrode-structured MZ multilevel optical intensity modulator according to the second exemplary embodiment. The optical modulator 200 has a configuration in which the calibration driver DR100 is replaced with a calibration driver DR200. Further, the control circuit 13 includes a look-up table (hereinafter, referred to as a LUT) 131. The other configuration of the optical modulator 200 is similar to that of the optical modulator 100 and thereby a description thereof will be omitted.

The control circuit 13 changes the amplitude of the calibration driver DR200 based on the LUT131 by a control signal SIG20 when regulating the amplitude of the drive signals output from the drivers DR10 to DR12. Expected ratios k0, k1, and k2 of output amplitude values of the drivers DR10 to DR12 are stored in the LUT131 in advance.

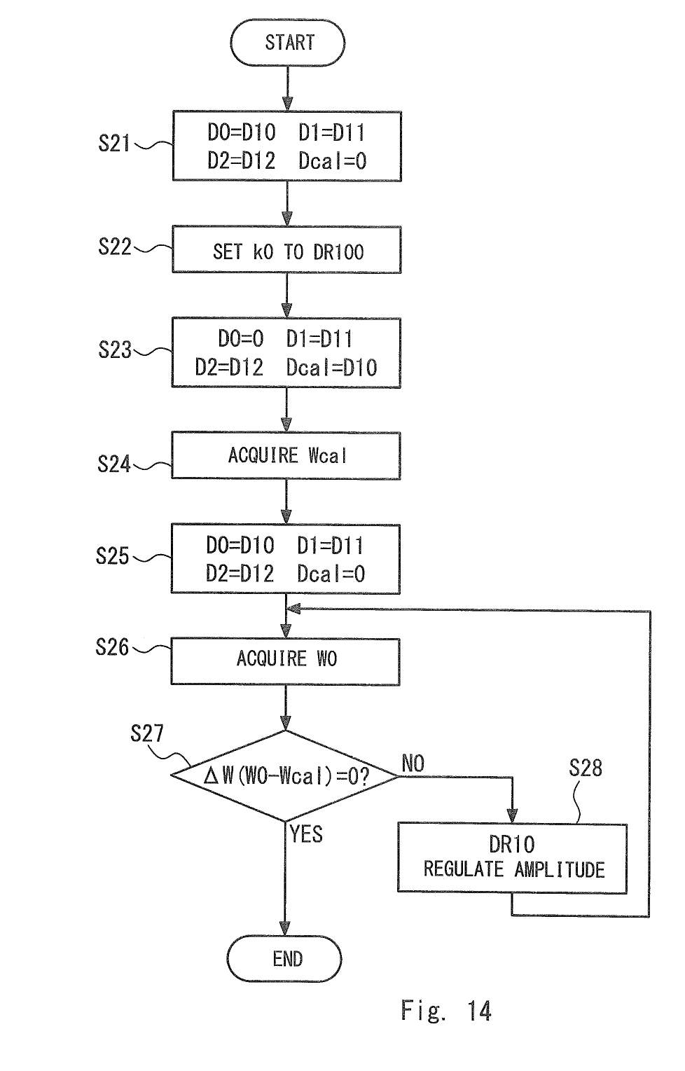

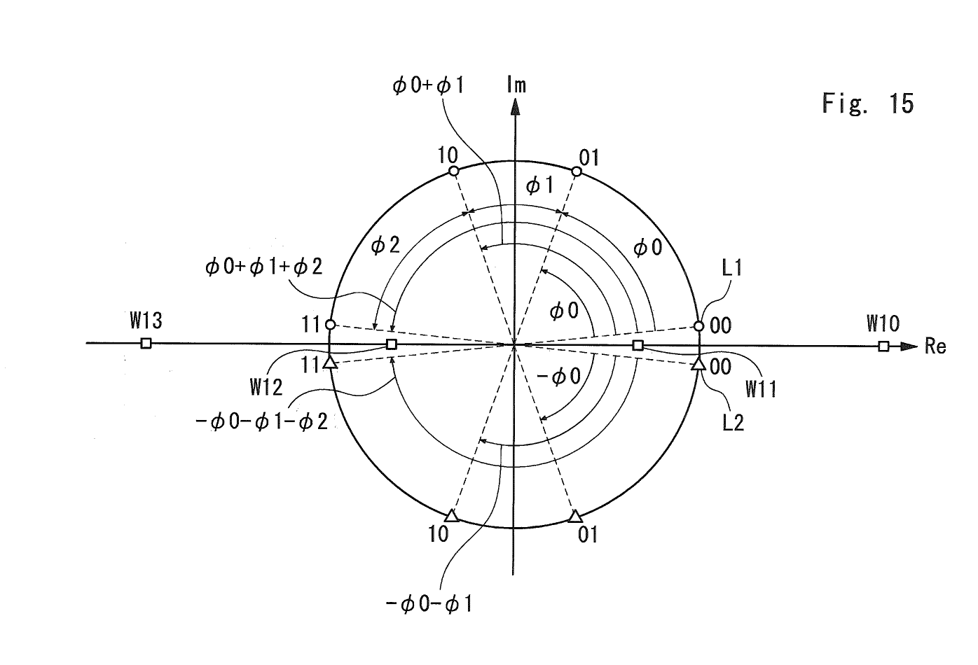

Next, a driver calibration operation of the optical modulator 200 to suppress the fluctuation of the characteristics will be described. FIG. 14 is a flow chart showing a procedure of the driver calibration operation of the optical modulator 200. Here, the driver DR10 is focused on and an operation in the case of calibrating the driver DR10 will be described.

### Step S21

Step S21 is similar to Step S11 of FIG. 10 and thereby a description thereof will be omitted.

### Step S22

The control circuit 13 refers to the LUT 131 and acquires an amplitude setup value k0 corresponding to the driver DR10. The control circuit 13 sets the output amplitude of the calibration driver DR200 to k0 by the control signal SIG20.

### Steps S23 to S28

Steps S23 to S28 are similar to Steps S12 to S17 of FIG. 10, respectively, and thereby a description thereof will be omitted.

Further, as described above, the similar calibration operations are performed on the drivers DR11 and DR12. An amplitude setup value k1 corresponding to the driver DR11 may be set as the output amplitude of the calibration driver DR200 when the driver DR11 is calibrated (Step S22). An amplitude setup value k2 corresponding to the driver DR12 may be set as the output amplitude of the calibration driver DR200 when the driver DR12 is calibrated (Step S22).

As a result, the phase shifts which the drivers DR10 to DR12 engage can be set in the ratios of k0:k1:k2, respectively.

Here, it is assumed that the phase shifts due to the calibration phase modulation areas PM10 and PM20 are φref_k0, φref_k1, and φref_k2 in a case that the amplitude settings of the calibration driver DR200 are k0, k1, k2. In this case, the phase shift φ0, which is applied by the phase modulation areas PM1_0 and PM2_0, satisfies φ0=φref_k0. The phase shift φ1, which is applied by the phase modulation areas PM1_1 and PM2_1, satisfies φ1=φref_k1. The phase shift φ2, which is applied by the phase modulation areas PM1_2 and PM2_2, satisfies φ2=φref_k2. Hence, a ratio of the phase shift due to each driver also satisfies φ0:φ1:φ2=k0:k1:k2, because the phase shift is in a proportional relation to a voltage applied to the phase modulation area in the optical modulator having excellent linearity. Even in the case of an optical modulator having inferior linearity, when nonlinearity thereof has been already known, it goes without saying that the ratios of φ0:φ1:φ2 can be optionally regulated by selecting k0, k1, and k2 in consideration of the nonlinearity in advance.

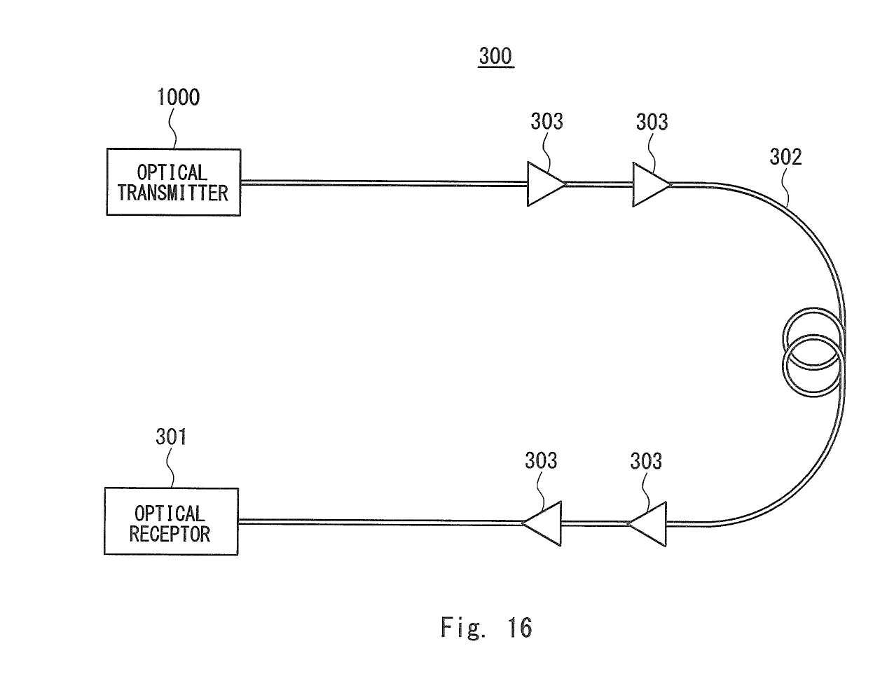

FIG. 15 is a constellation diagram of the optical modulator 200 when φ0+φ1+φ2 is approximately π. In FIG. 15, the output optical signals are referred as W10, W11, W12, and W13 when the phase shifts are 0, φ0, φ1, and φ2, respectively. the ratios of φref_k0, φref_k1, and φref_k2 coincide with values of k0, k1, and k2 that are stored in the LUT 131 in advance, respectively. Accordingly, the four-point constellation based on the phase modulation of the ratios of k0, k1, and k2. Further, the optical intensity can be represented by a distance from the origin. Here, four-level optical output signal is acquired when the sign information is included. (W10 and W13 have the same optical intensity each other and have different signs. W11 and W12 have the same optical intensity each other and have different signs. In sum, these mean that an optical phase is inverted by 180 degrees.) In this case, as shown in FIG. 15, the optical modulated light having precisely equally-spaced optical signal intensity of four levels can be obtained when the intensity ratio is stored in the LUT 131 in advance to cause the spacing of the four-level output optical signals to be even.

Note that the intensity ratios (k0, K1, and k2) of the optical signals can be calculated from an ARCCOS function. However, the setup values (k0, K1, and k2) stored in the LUT 131 are not necessarily the ARCCOS function. It is possible to correct a non-linearity of each driver as approximated by a hyperbolic tangent function and another different and arbitrary non-linearity can be corrected.

As described above, according to the optical modulator and the calibration operation, it is possible to provide the optical modulator capable of matching the optical modulation characteristics of each segmented electrode in the background without interrupting the regular operation or communication. Further, according to the configuration, the optical modulator capable of correcting the non-linearity of the output optical signal can be provided.

### Third Exemplary Embodiment

Next, an optical transmission/reception system 300 according to a third exemplary embodiment will be described. The optical transmission/reception system 300 is an optical transmission/reception system using either the above-mentioned optical transmitter 1000 or the above-mentioned optical transmitters 2000. Here, an example where the optical transmission/reception system 300 includes the optical transmitter 1000 will be described. FIG. 16 is a block diagram schematically showing a configuration of the optical transmission/reception system 300 according to the third exemplary embodiment.

The optical transmission/reception system 300 includes the optical transmitter 1000, an optical receptor 301, an optical transmission line 302, and an optical amplifier 303.

The optical transmitter 1000 outputs, for example, a 16QAM (Quadrature Amplitude Modulation) optical signal on which a 16QAM is performed as an optical signal. Note that the optical transmitter 1000 may output a quadrature phase-shift-keying signal, a PAM signal, and so on as the optical signal.

The optical transmission line 302 optically connects between the optical transmitter 1000 and the optical receptor 301, and the 16QAM optical signal propagates therebetween. The optical amplifier 303 is inserted in the optical transmission line 302 and amplifies the 16QAM optical signal propagating through the optical transmission line 302. The optical receptor 301 demodulates the 16QAM optical signal into an electric signal.

According to the above-mentioned configuration, the optical transmission/reception system 300 can transmit the optical signal using the optical transmitter 1000. It should be appreciated that the optical transmitter 1000 can be appropriately replaced with the optical transmitter 2000.

### Other Exemplary Embodiments

The present invention is not limited to the above-described exemplary embodiments, and can be modified as appropriate without departing from the scope of the invention. In the above exemplary embodiments, the above-mentioned calibration operation may be performed as an initial setup at the time of introduction.

In the above exemplary embodiments, the calibration driver and the calibration phase modulation area may be either fixed or appropriately changed. That is, the calibration driver and the calibration phase modulation area can be appropriately rotated in the plurality of the drivers and the plurality of the phase modulation areas provided in the optical modulator. It is possible in some cases that fluctuation in the monitored value in the optical power monitor tends not to occur when the optical modulation characteristics fluctuates due to the driving or modulation scheme. Accordingly, the calibration by the amplitude adjustment becomes difficult. In this case, a role of each of the phase modulation areas and drivers is rotated and the optical modulation characteristics are averaged by appropriately rotating the calibration phase modulation areas and calibration drivers, so that the problem described above can be prevented.

Further, according to the present calibration measure in the exemplary embodiments described above, the calibration is performed in a manner that the amplitude of each of the drivers DR10 to DR12 regularly coincide with the amplitude of the calibration driver DR100. However, when the amplitude of the calibration driver DR100 itself varies due to ambient conditions or aging degradation, the amplitude of each of the drivers DR10 to DR12 totally varies and the intensity of the output optical signal totally varies. With respect to the problem, the problem can be solved by multiplying the amplitude of each driver to keep the light intensity information INF that is a monitor result of the output optical signal intensity at a desired value or adjusting the amplitude value of the calibration driver that is the reference.

Furthermore, in the second exemplary embodiment described above, an example where the amplitude of the calibration driver is variable according to the LUT 131 is described, a method where the amplitude of the calibration driver is constant and a setup amplitude value of each of the drivers DR10 to DR12, which is an objective of the calibration, is variable according to the LUT 131. In this case, a procedure where an amplitude setup of the driver DR10, which is the objective of the calibration is multiplied according to an expected amplitude value stored in the LUT131 after the repeatedly calibrating until ΔW=0 (Here, the amplitude of the calibration driver coincides with the amplitude of the DR10 that is the objective of the calibration.) shown in the steps S26 to S28 in FIG. 14 is needed. However, according to the method, it is not guaranteed whether the expected amplitude value is really achieved due to the fluctuation of the driver characteristics after multiplying according to the LUT 131. Therefore, it can be considered that the method of the second exemplary embodiment of the present suggestion is preferable.

The configuration and calibration method of the optical modulator described in the above exemplary embodiments can be also applied to an I (In-phase)/Q (Quadrature) modulator as well as the single Mach-Zehnder optical modulator. Further, the case where signals are provided in both of right and left sides of the imaginary axis on the complex plane that is a basis for the IQ modulator generating a QPSK signal, a QAM signal, and so on. However, it can be applied to the PAM signal using only the right half, etc.

In the above exemplary embodiments, an example where the optical intensity is varied in four levels is described. However, it goes without saying that the optical intensity can be varied in levels other than four levels by increasing or decreasing the number of the phase modulation areas. That is, the optical intensity can be varied in arbitrary levels more than four levels by providing two or more phase modulation areas and two or more drivers on the single waveguide in the optical modulator.

In the above description, the case where the temperature gauge code is generated in the decoder 121, however, it is merely an example. For example, it goes without saying that the output optical signal as a four-level PAM signal can be obtained by driving the driver DR10 by the signal D0 and driving the drivers DR11 and DR12 by the signal D1 even when driving by not the temperature gauge code but a binary signal as-is.

There may be a multiple pairs of the calibration phase modulation areas. There are multiple calibration drivers. In this case, although assignment variations of the drive signal increase, the same function as the above-mentioned calibration method can be achieved by adjusting the amplitude of the driver to eliminate a difference in the optical power monitor between the regular phase modulation area and the calibration phase modulation area.

In the second exemplary embodiment, the output amplitude of the calibration driver DR20 is adjusted in the step S23 (FIG. 14) and the output amplitudes of the drivers DR12 to DR12 are adjusted in the step S26 (FIG. 14), however, it is merely an example. For example, in so far as enough calibration accuracy can be kept, the control circuit 1 may appropriately adjust the amplitude of each driver based on the LUT 131 after averaging the phase shift by each phase modulation area as described in the first exemplary embodiment.

The above optical modulator is configured as N-level of two or more bits optical modulator. Accordingly, it can be understood that at least one calibration phase modulation area is provided on each optical waveguide in addition to 2^{N}-1 phase modulation areas used for a general optical modulation. That is, in the above-mentioned optical modulator, 2^{N} or more phase modulation areas are provided on each optical waveguide.

The present invention has been described above with reference to exemplary embodiments, but the present invention is not limited to the above exemplary embodiments. The configuration and details of the present invention can be modified in various manners which can be understood by those skilled in the art within the scope of the invention.

This application is based upon and claims the benefit of priority from Japanese patent application No. 2013-53193, filed on Mar. 15, 2013, the disclosure of which is incorporated herein in its entirety by reference.

### REFERENCE SIGNS LIST

11, 61 OPTICAL MODULATION UNITS
12 SIGNAL DISTRIBUTION CIRCUIT
13 CONTROL CIRCUIT
14, 63 DRIVE CIRCUITS
62, 121 DECODERS
100, 200, 600 OPTICAL MODULATORS
111, 112, 611, 612 OPTICAL WAVEGUIDES
113, 114, 613, 614 OPTICAL MULTIPLEXERS/DEMULTIPLEXERS
122 SIGNAL DISTRIBUTION UNIT
300 OPTICAL TRANSMISSION/RECEPTION SYSTEM
301 OPTICAL RECEPTOR
302 OPTICAL TRANSMISSION LINE
303 OPTICAL AMPLIFIER
1000, 6000 OPTICAL TRANSMITTERS
1001, 6001 LIGHT SOURCES
1002, 6002 LIGHTS
1003, 6003 OPTICAL SIGNALS
DIN INPUT DIGITAL SIGNAL
D10-D12 THE TEMPERATURE GAUGE CODES
D0-D2, DCALSIGNALS
DR10-DR12 DRIVERS
DR100, DR200 CALIBRATION DRIVERS
DR60 DRIVER
DR60-DR62 DRIVERS
IN INPUT LIGHT
INF LIGHT INTENSITY INFORMATION
L1, L2
OUT OPTICAL SIGNAL
P1, P2, P5, P6 INPUT PORTS
P3, P4, P7, P8 OUTPUT PORTS
PM1_0-PM1_2, PM2_0-PM2_2, PM61_0-PM61_2 PHASE MODULATION AREAS
PM10, PM20 CALIBRATION PHASE MODULATION AREAS
SIG0-SIG2, SIG10, SIG20 CONTROL SIGNALS

What is claimed is:

1. An optical modulator comprising:
an optical modulation unit that modulates an input light into an optical signal of n (n is an integer equal to or more than two) levels and outputs the optical signal, a plurality of phase modulation areas being formed on a waveguide in the optical modulation unit;
a signal distribution circuit that outputs a signal based on an input digital signal;
a drive circuit that includes a plurality of drivers connected to the plurality of phase modulation areas, respectively, and outputs drive signals according to the signal based on the input digital signal to the plurality of drivers connected to the plurality of phase modulation areas, respectively; and
a control circuit that calibrates amplitude of the drive signal output from each driver connected to a phase modulation area that is a calibration objective and is other than a phase modulation area that is a calibration reference according to light intensity of the optical signal in order to coincide with a phase shift by the phase modulation area that is the calibration reference in the plurality of phase modulation areas.

2. The optical modulator according to claim 1, wherein
the control circuit:
selects one phase modulation area that is the calibration reference from the plurality of phase modulation areas;
obtains light intensity of the optical signal when the optical modulation is performed with using the phase modulation area that is the calibration reference and without using the phase modulation area that is the calibration objective as first light intensity;
obtains light intensity of the optical signal when the optical modulation is performed without using the phase modulation area that is the calibration reference and with using the phase modulation area that is the calibration objective as second light intensity; and
calibrates the amplitude of the drive signal output from the driver corresponding to the phase modulation area that is the calibration objective to eliminate a difference between the first light intensity and the second light intensity.

3. The optical modulator according to claim 2, wherein
the control circuit changes the phase modulation area that is the calibration reference in the plurality of phase modulation areas.

4. The optical modulator according to claim 1, wherein
the control circuit can adjust the amplitude of the drive signal output from the driver connected to the phase modulation area that is the calibration reference, and adjusts the amplitude of the drive signal output from the driver connected to the phase modulation area that is the calibration reference for each driver connected to the phase modulation area that is the calibration objective.

5. The optical modulator according to claim 4, wherein
the control circuit includes a table storing information indicating the amplitude of the drive signal output from the driver connected to the phase modulation area that is the calibration reference for each driver connected to the phase modulation area that is the calibration objective, and
the control circuit adjusts the amplitude of the drive signal output from the driver connected to the phase modulation area that is the calibration reference by referring to the table.

6. The optical modulator according to claim 1, wherein
the optical modulation unit generates the optical signal by multiplexing the input lights split into two after phase-modulating both or one of the input lights split into two, the input lights split into two propagating thorough two optical waveguides, respectively.

7. The optical modulator according to claim 1, wherein
the optical modulation unit comprises:
a first optical multiplexer/demultiplexer that demultiplexes the input light into a first input light and a second input light;
a first optical waveguide through which the first input light propagates;
a second optical waveguide through which the second input light propagates;
a second optical multiplexer/demultiplexer that multiplexes a light output from the first optical waveguide and a light output from the second optical waveguide;
a plurality of first phase modulation areas that are formed on the first optical waveguide; and
a plurality of second phase modulation areas that are formed on the second optical waveguide.

8. The optical modulator according to claim 1, further comprising a monitor circuit that monitors intensity of the optical signal and outputs a monitor result to the control circuit.

9. The optical modulator according to claim 7, wherein
the optical modulation unit includes:
the m (m is an integer equal to or more than 2ⁿ) first phase modulation areas; and
the m second phase modulation areas,
the drive circuit includes the m drivers,
each of the m drivers is connected to any of the m first phase modulation areas or any of the m second phase modulation areas without overlapping with the other drivers,
the control circuits:
selects one phase modulation area that is the calibration reference from the m first phase modulation areas;
calibrates the phase modulation areas other than the phase modulation area that is the calibration reference in the m first phase modulation areas as the phase modulation areas that are the calibration objectives;
selects one phase modulation area that is the calibration reference from the m second phase modulation areas; and
calibrates the phase modulation areas other than the phase modulation area that is the calibration reference in the m second phase modulation areas as the phase modulation areas that are the calibration objectives.

10. An optical transmitter comprising:
an optical modulation unit that modulates an input light into an optical signal of n (n is an integer equal to or more than two) levels and outputs the optical signal, a plurality of phase modulation areas being formed on a waveguide in the optical modulation unit;
a light source that outputs the input light;
a monitor unit that monitors light intensity of the optical signal;
a signal distribution circuit that outputs a signal based on an input digital signal;
a drive circuit that includes a plurality of drivers connected to the plurality of phase modulation areas, respectively, and outputs drive signals according to the signal based on the input digital signal to the plurality of drivers connected to the plurality of phase modulation areas, respectively; and
a control circuit that calibrates amplitude of the drive signal output from each driver connected to a phase modulation area that is a calibration objective and is other than a phase modulation area that is a calibration reference according to the light intensity of the optical signal in order to coincide with a phase shift by to the phase modulation area that is the calibration reference in the plurality of phase modulation areas.

11. An optical transmission/reception system comprising:
an optical transmitter that outputs an optical signal; and
an optical receptor that receives the optical signal,
wherein
the optical transmitter comprises:
an optical modulation unit that modulates an input light into the optical signal of n (n is an integer equal to or more than two) levels and outputs the optical signal, a plurality of phase modulation areas being formed on a waveguide in the optical modulation unit;
a light source that outputs the input light;
a monitor unit that monitors light intensity of the optical signal;
a signal distribution circuit that outputs a signal based on an input digital signal;
a drive circuit that includes a plurality of drivers connected to the plurality of phase modulation areas, respectively, and outputs drive signals according to the signal based on the input digital signal to the plurality of drivers connected to the plurality of phase modulation areas, respectively; and
a control circuit that calibrates amplitude of the drive signal output from each driver connected to a phase modulation area that is a calibration objective and is other than a phase modulation area that is a calibration reference according to the light intensity of the optical signal in order to coincide with a phase shift by to the phase modulation area that is the calibration reference in the plurality of phase modulation areas.

12. A control method for an optical modulator comprising:
monitoring light intensity of an optical signal output from an optical modulation unit that modulates an input light into the optical signal of n (n is an integer equal to or more than two) levels and outputs the optical signal by a plurality of phase modulation areas formed on a waveguide;
generating a signal based on an input digital signal;
outputting drive signals to corresponding phase modulation areas from a plurality of drivers connected to the plurality of phase modulation area, respectively, according to the signal based on the input digital signal;
calibrating amplitude of the drive signal output from each driver connected to a phase modulation area that is a calibration objective and is other than a phase modulation area that is a calibration reference according to the light intensity of the optical signal in order to coincide with a phase shift by the phase modulation area that is the calibration reference in the plurality of phase modulation areas.
